(19) United States
(12) Patent Application Publication
(10) Pub. No.: US 2002/0079159 A1
(43) Pub. Date: Jun. 27, 2002

(54) Double layer acoustic liner and a fluid pressurizing device and method utilizing same

(75) Inventor: Zheji Liu, Olean, NY (US)

Correspondence Address: HAYNES AND BOONE, LLP, 901 MAIN STREET, SUITE 3100, DALLAS, TX, 75202, US

(73) Assignee: Dresser-Rand Company, Olean, NY (US)

(21) Appl. No.: 09/929,193

(22) Filed: Aug. 14, 2001

Related U.S. Application Data
(63) Continuation of application No. 09/745,862, filed on Dec. 21, 2000.

(51) Int. Cl. B64F 1/26; G10K 11/00; E04H 17/00

(52) U.S. Cl. 181/210; 181/224

(57) ABSTRACT

This invention relates to a double layer acoustic liner for attenuating noise and consisting of a plurality of cells formed in a plate in a manner to form an array of resonators, and a fluid processing device and method incorporating same.

### CROSS REFERENCE TO RELATED APPLICATION

This application is a continuing application of co-pending parent application Ser. No. 09/745,862 filed on Dec. 21, 2000.

### BACKGROUND

This invention relates to an acoustic liner of two layers and a fluid pressurizing device and method utilizing same.

Fluid pressurizing devices, such as centrifugal compressors, are widely used in different industries for a variety of applications involving the compression, or pressurization, of a gas. However, a typical compressor produces a relatively high noise level which is an obvious nuisance to the people in the vicinity of the device. This noise can also cause vibrations and structural failures.

For example, the dominant noise source in a centrifugal compressor is typically generated at the locations of the impeller exit and the diffuser inlet, due to the high velocity of the fluid passing through these regions. The noise level becomes higher when discharge vanes are installed in the diffuser to improve pressure recovery, due to the aerodynamic interaction between the impeller and the diffuser vanes.

Various external noise control measures such as enclosures and wrappings have been used to reduce the relative high noise levels generated by compressors, and similar devices. These external noise reduction techniques can be relatively expensive especially when they are often offered as an add-on product after the device is manufactured.

Also, internal devices, usually in the form of acoustic liners, have been developed which are placed in the compressors, or similar devices, for controlling noise inside the gas flow paths. These liners are often based on the well-known Helmholtz resonator principle according to which the liners dissipate the acoustic energy when the sound waves oscillate through perforations in the liners, and reflect the acoustic energy upstream due to the local impedance mismatch caused by the liner. Examples of Helmholtz resonators are disclosed in U.S. Pat. Nos. 4,100,993; 4,135,603; 4,150,732; 4,189,027; 4,443,751; 4,944,362; and 5,624,518.

A typical Helmholtz array acoustic liner is in the form of a three-piece sandwich structure consisting of honeycomb cells sandwiched between a perforated facing sheet and a back plate. Although these three-piece designs have been successfully applied to suppress noise in aircraft engines, it is questionable whether or not they would work in fluid pressurizing devices, such as centrifugal compressors. This is largely due to the possibility of the perforated facing sheet of the liner breaking off its bond with the honeycomb under extreme operating conditions of the compressor, such as, for example, during rapid depressurization caused by an emergency shut down of the compressor. In the event that the perforated facing sheet becomes loose, it not only makes the acoustic liners no longer functional but also causes excessive aerodynamic losses, and even the possibility of mechanical catastrophic failure, caused by the potential collision between the break-away perforated sheet metal and the spinning impeller.

Therefore what is needed is a system and method for reducing the noise in a fluid pressurizing device utilizing a Hemholtz array acoustic liner while eliminating its disadvantages.

### SUMMARY

Accordingly an acoustic liner is provided, as well as a fluid processing device and method incorporating same, according to which the liner attenuates noise and consists of one or more acoustic liners each including a plurality of cells formed in a plate in a manner to form an array of resonators.

### BRIEF DESCRIPTION OF THE DRAWINGS

FIG. 1 is a cross-sectional view of a portion of a gas pressurizing device incorporating a pair of acoustic liners according to an embodiment of the present invention.

FIG. 2 is an enlarged cross-sectional view of one of the acoustic liners of FIG. 1.

FIG. 3 is an enlarged elevational view of a portion of the liner of FIG. 2.

FIGS. 4 and 5 are views similar to that of FIG. 1, but depicting additional acoustic liners disposed at other locations in the fluid pressurizing device.

### DETAILED DESCRIPTION

FIG. 1 depicts a portion of a high pressure fluid pressurizing device, such as a centrifugal compressor, including a casing 10 defining an impeller cavity 10a for receiving an impeller 12 which is mounted for rotation in the cavity. It is understood that a power-driven shaft (not shown) rotates the impeller 12 at a high speed, sufficient to impart a velocity pressure to the gas drawn into the compressor via the inlet.

The impeller 12 includes a plurality of impeller blades 12a arranged axisymmetrically around the latter shaft for discharging the gas into a diffuser passage, or channel 14 formed in the casing 10 radially outwardly from the chamber 10a and the impeller 12. The channel 14 receives the high pressure fluid from the impeller 12 before it is passed to a volute, or collector,16. The diffuser channel 14 functions to convert the velocity pressure of the gas into static pressure which is coupled to a discharge volute, or collector 16 also formed in the casing and connected with the channel. Although not shown in FIG. 1, it is understood that the discharge volute 16 couples the compressed gas to an outlet of the compressor.

Due to centrifugal action of the impeller blades 12a, gas can be compressed to a relatively high pressure. The compressor is also provided with conventional labyrinth seals, thrust bearings, tilt pad bearings and other apparatus conventional to such compressors. Since this structure is conventional, it will not be shown or described in any further detail.

A mounting bracket 20 is secured to an inner wall of the casing 10 defining the diffuser channel 14 and includes a base 22 disposed adjacent the outer end portion of the impeller and a plate 24 extending from the base and along the latter wall of the casing.

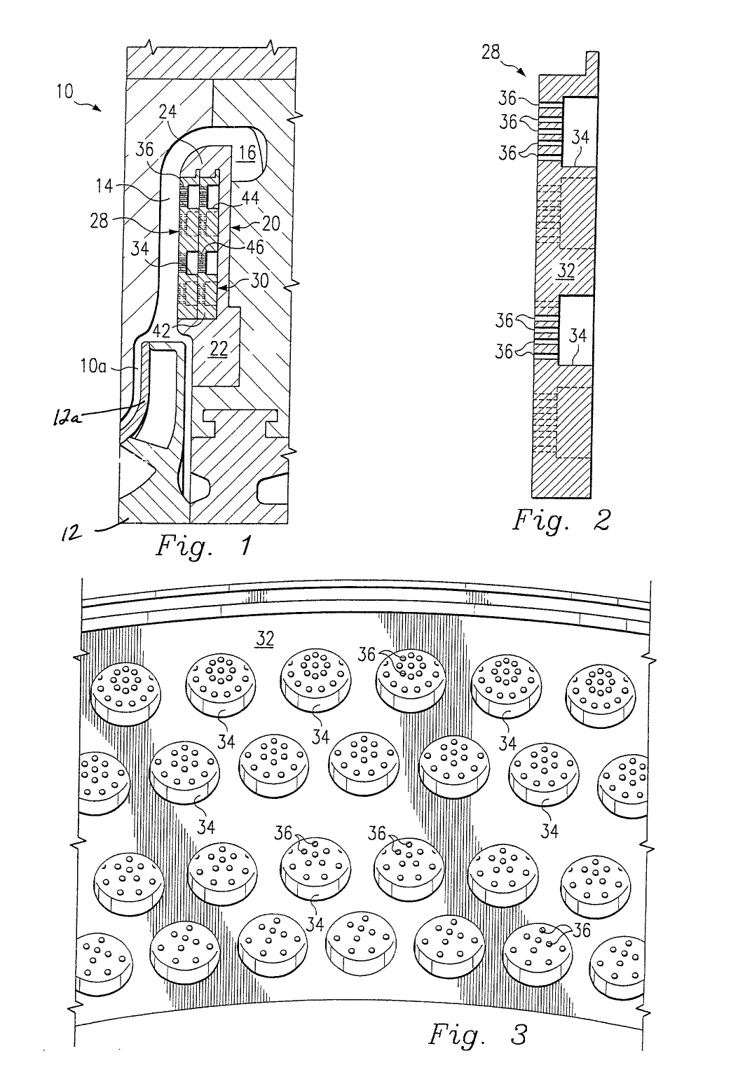

Two one-piece, unitary, annular acoustic liners 28 and 30 are mounted in a groove in the plate 24 of the bracket 20 in a abutting relationship and each is annular in shape and extends around the impeller 12 for 360 degrees. The upper section of the liner 28 is shown in detail in FIGS. 2 and 3, and is formed of an annular, relatively thick, unitary shell, or plate 32 preferably made of steel. The plate 32 is attached to the bracket plate 24 in any conventional manner, such as by a plurality of bolts, or the like.

A series of relatively large cells, or openings, 34 are formed through one surface of the plate 32 and extend through a majority of the thickness of the plate but not through its entire thickness. A series of relatively small cells 36 extend from the bottom of each cell 34 to the opposite surface of the plate 32. Each cell 34 is shown having a disc-like cross section and each cell 36 is in the form of a bore for the purpose of example, it being understood that the shapes of the cells 34 and 36 can vary within the scope of the invention.

According to one embodiment of the present invention, each cell 34 is formed by drilling a relative large-diameter counterbore through one surface of the plate 32, which counterbore extends through a majority of the thickness of the plate but not though the complete thickness of the plate. Each cell 36 is formed by drilling a bore, or passage, through the opposite surface of the plate 32 to the bottom of a corresponding cell 34 and thus connects the cell 34 to the diffuser channel 14.

As shown in FIG. 3, the cells 34 are formed in a plurality of annular extending rows along the entire annular area of the plate 32, with the cells 34 of a particular row being staggered, or offset, from the cells of its adjacent row(s). A plurality of cells 36 are associated with each cell 34 and the cells 36 can be randomly disposed relative to their corresponding cell 34, or, alternately, can be formed in any pattern of uniform distribution.

With reference to FIG. 1, the liner 30 is similar to the liner 28 and, as such, is formed of an annular, relatively thick, unitary shell, or plate 42 (FIG. 1), preferably made of steel, and is attached to the liner 28 in any conventional manner such as by a plurality of bolts, or the like. A series of relatively large cells, or openings, 44 are formed through one surface of the plate 42 and a series of relatively small cells 46 extend from the bottom of each cell 34 to the opposite surface of the plate 32. Since the cells 44 and 46 are similar to the cells 34 and 36, respectively, they will not be described in further detail. Although not shown in the drawings, it is understood that the liners 30 and 28 can be of different thickness.

The liners 28 and 30 are mounted in the bracket plate 24 with the surface of the liner 28 through which the cells 34 extend abutting the surface of the liner 30 through which the cells 46 extend. Also, the cells 34 of the liner 28 are in alignment with the cells 44 of the liner 30. The open ends of the cells 44 of the liner 30 are capped by the underlying wall of the plate 24 of the bracket 20, and the open ends of the cells 34 of the liner 28 are capped by the corresponding surface of the liner 30. The cells 34 of the liner 28 and the cells 44 of the liner 30 are connected by the cells 46 of the liner 30, due to their alignment.

Due to the firm contact between the liners 28 and 30, and between the liner 30 and the corresponding wall of the plate 24 of the bracket 20, and due to the cells 36 and 46 connecting the cells 34 and 44 to the diffuser channel 14, the cells work collectively as an array of acoustic resonators in series. As such, the liners 28 and 30 attenuate the sound waves generated in the casing 10 by the fast-rotation of the impeller 12, and by its associated components, and eliminate, or at least minimize, the possibility that the noise will by-pass the liners and pass through a different path.

Moreover, the dominant noise component commonly occurring at the blade passing frequency, or other high frequency can be effectively lowered by tuning the liners 28 and 30 so that the maximum sound attenuation occurs around the latter frequency. This can be achieved by varying the volume of the cells 34 and 44, and/or the cross-section area, the number, and/or the length of the cells 36 and 46. The provision of the two liners 28 and 30 enables them to attenuate noise in a much wider frequency range than if a single liner were used, thus enabling a maximum amount of attenuation of the acoustic energy generated by the rotating impeller 12 and its associated components to be achieved.

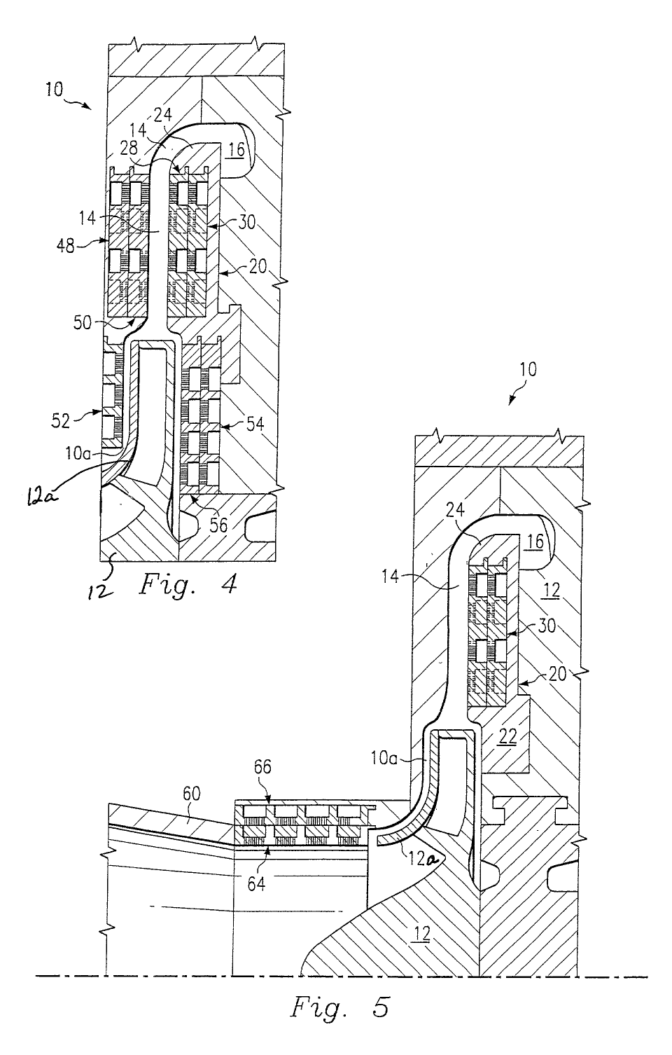

According to the embodiment of FIG. 4, two one-piece, unitary, annular liners 48 and 50 are secured in a groove formed in the internal wall of the casing 10 opposite to the liners 28 and 30. The liner 48 extends in the bottom of the groove and is connected to the structure forming the groove in any conventional manner, such as by a plurality of bolts, or the like; and the liner 50 extends in the groove in an abutting relationship to the liner 48 and is connected to the liner 48 in any conventional manner, such as by a plurality of bolts, or the like. The liner 50 partially defines, with the liner 30, the diffuser channel 14. Since the liners 48 and 50 are similar to, and functions the same as, the liners 28 and 30, they will not be described in any further detail.

Due to the firm contact between the liners 48 and 50, and between the liner 48 and the corresponding wall of the casing 10, and due to the arrangement of the respective cells of the liners, the cells work collectively as arrays of acoustic resonators in series. As such, the liners 48 and 50 attenuate the sound waves generated in the casing 10 by the fast-rotation of the impeller 12, and by its associated components, and eliminate, or at least minimize, the possibility that the noise will by-pass the liners and pass through a different path.

Moreover, the dominant noise component commonly occurring at the blade passing frequency, or other high frequency can be effectively lowered by tuning the liners 48 and 50 so that the maximum sound attenuation occurs around the latter frequency. This can be achieved by varying the volume and/or the cross-section area, the number, and/or the length of their respective cells. The provision of the two liners 48 and 50 enables them to attentuate noise in a much wider frequency range than if a single liner were used, thus enabling a maximum amount of attenuation of the acoustic energy generated by the rotating impeller 12 and its associated components to be achieved.

Also, two one-piece, unitary, annular liners 54 and 56 are mounted in a groove formed in the casing 10 to the rear of the impeller 12. The liner 54 extends in the bottom of the groove and is connected to the structure forming the groove in any conventional manner, such as by a plurality of bolts, or the like; and the liner 56 extends in the groove in an abutting relationship to the liner 54 and is connected to the liner 54 in any conventional manner, such as by a plurality of bolts, or the like. The liner 56 partially defines, with the liner 52, the chamber in which the impeller 12 rotates.

The liners 54 and 56 have a smaller outer diameter than the liners 28, 30, 48 and 50, but otherwise are similar to, and are mounted in the same manner as, the latter liners.

Due to the firm contact between the liners 54 and 56, and between the liner 54 and the corresponding wall of the casing 10, and due to the arrangement of the respective cells of the liners, the cells work collectively as arrays of acoustic resonators in series. As such, the liners 54 and 56 attenuate the sound waves generated in the casing 10 by the fast-rotation of the impeller 12, and by its associated components, and eliminate, or at least minimize, the possibility that the noise will by-pass the liners and pass through a different path.

Moreover, the dominant noise component commonly occurring at the blade passing frequency, or other high frequency can be effectively lowered by tuning the liners 54 and 56 so that the maximum sound attenuation occurs around the latter frequency. This can be achieved by varying the volume and/or the cross-section area, the number, and/or the length of their respective cells. The provision of the two liners 54 and 56 enables them to attenuate noise in a broader frequency range than if a single liner were used, thus enabling a maximum amount of attenuation of the acoustic energy generated by the rotating impeller 12 and its associated components to be achieved.

Still another preferred location for liners is shown in FIG. 5 which depicts an inlet conduit 60 that introduces gas to the inlet of the impeller 12. The upper portion of the conduit 60 is shown extending above the centerline C/L of the conduit and the casing 10, as viewed in FIG. 5.

A one-piece, unitary, liner 64 is flush-mounted on the inner wall of the conduit 60 with the radial outer portion being shown. The liner 64 is in the form of a curved shell, preferably cylindrical or conical in shape, is disposed in an annular groove formed in the inner surface of the conduit 60, and is secured in the groove in any known manner. Since the liner 64 is otherwise similar to the liners 28, 30, 48, 50, 52, 54, and 56, it will not be described in further detail.

A one-piece, unitary, liner 66 is also disposed in the latter annular groove and extends around the liner 64 with its inner surface abutting the outer surface of the liner 64. The liner 66 is in the form of a curved shell, preferably cylindrical or conical in shape having a diameter larger than the diameter of the liner 64 and is secured to the liner 64 in any conventional manner, such as by a plurality of bolts, or the like. Since the liners 64 and 66 are otherwise similar to the liners 28, 30, 48, 50, 52, 54, and 56, and function in the same manner to significantly reduce the noise in the casing 10, they will not be described in further detail.

Due to the firm contact between the liners 64 and 66, and between the liner 66 and the corresponding wall of the casing 10 defining the latter groove, and due to the arrangement of the respective cells of the liners, and their location relative the inlet conduit 60, the cells work collectively as arrays of acoustic resonators in series. As such, the liners 64 and 66 attenuate the sound waves generated in the casing 10 by the fast-rotation of the impeller 12, and by its associated components, and eliminate, or at least minimize, the possibility that the noise will by-pass the liners and pass through a different path.

Moreover, the dominant noise component commonly occurring at the blade passing frequency, or other high frequency can be effectively lowered by tuning the liners 64 and 66 so that the maximum sound attenuation occurs around the latter frequency. This can be achieved by varying the volume and/or the cross-section area, the number, and/or the length of their respective cells. The provision of the two liners 64 and 66 enables them to attenuate noise in a broader frequency range than if a single liner were used, thus enabling a maximum amount of attenuation of the acoustic energy generated by the rotating impeller 12 and its associated components to be achieved.

Also, given the fact that the frequency of the dominant noise component in a fluid pressurizing device of the above type varies with the compressor speed, the number of the smaller cells per each larger cell of each liner can be varied spatially across the liners so that the entire liner is effective to attenuate noise in a broader frequency band. Consequently, the liners 28, 30, 48, 50, 52, 54, 56, 64, and 66 can efficiently and effectively attenuate noise, not just in constant speed machines, but also in variable speed compressors, or other fluid pressurizing devices.

In addition to the attenuation of the acoustic energy and the elimination of by-passing of the latter energy, as discussed above, the one-piece unitary construction of the liners in the above embodiments renders the liners mechanically stronger when compared to the composite designs discussed above. Thus, the liners provide a very rigid inner wall to the internal flow in the fluid pressurizing device, and have less or no deformation when subject to mechanical and thermal loading, and thus have no adverse effect on the aerodynamic performance of a fluid pressurizing device, such as a centrifugal compressor, even when they are installed in the narrow passages such as the diffusor channels, or the like.

### VARIATIONS

The specific arrangement and number of liners in accordance with the above embodiments are not limited to the number shown. Thus, the liners to either side of the diffuser channel and/or the impeller and/or the inlet conduit.

The specific technique of forming the cells in the liners can vary from that discussed above. For example, a one-piece liner can be formed in which the cells are molded in their respective plates.

The relative dimensions, shapes, numbers and the pattern of the cells of each liner can vary.

The liners are not limited to use with a centrifugal compressor, but are equally applicable to other fluid pressurizing devices in which aerodynamic effects are achieved with movable blades.

Each liner can extend for degrees around the axis of the impeller and the inlet conduit as disclosed above; or each liner can be formed into segments which extend an angular distance less than 360 degrees.

The spatial references used above, such as “bottom”, “inner”, “outer”, “side” etc, are for the purpose of illustration only and do not limit the specific orientation or location of the structure.

Since other modifications, changes, and substitutions are intended in the foregoing disclosure, it is appropriate that the appended claims be construed broadly and in a manner consistent with the scope of the invention.

What is claimed is:

1. A noise attenuation assembly comprising a first one-piece, unitary, acoustic liner comprising a unitary plate, and a plurality of cells formed in the plate in a manner to form an array of resonators to attenuate acoustic energy; and a second one-piece, unitary, acoustic liner disposed in an abutting relationship to the first liner, the second liner comprising a unitary plate, and a plurality of cells formed in the plate in a manner to form an array of resonators to attenuate acoustic energy.

2. The assembly of claim 1 wherein the cells of the second liner are aligned with the cells of the first liner so that a series of resonators are formed in the lateral direction.

3. The assembly of claim 1 wherein the resonators are either Helmholtz resonators or quarter-wave resonators.

4. The assembly of claim 1 wherein the cells of each liner are in the form of a first series of openings extending from one surface of the plate, and a second series of openings extending from the opposite surface of the plate.

5. The assembly of claim 4 where a plurality of openings of the second series of openings extend to one of each of the first series of openings.

6. The assembly of claim 4 wherein each opening of the first series of openings is larger than each opening of the second series of openings.

7. The assembly of claim 4 wherein the surface of the first liner through which the first series of opening extends abuts the surface of the second liner through which the second series of cells extend.

8. The assembly of claim 4 wherein the first and second series of openings are uniformly dispersed in their respective plates.

9. The assembly of claim 4 wherein the number and size of the openings are constructed and arranged to tune their corresponding liner to attenuate the dominant noise component of acoustic energy associated with the assembly.

10. A fluid pressurizing device comprising a casing defining an inlet, and an outlet; an impeller mounted in the casing and having a plurality of flow passages extending therethrough, the impeller adapted to rotate to flow fluid from the inlet, through the passages, and to the outlet for discharge from the casing; a one-piece, unitary, acoustic liner disposed in the casing, the liner comprising a unitary plate, and a plurality of cells formed in the plate in a manner to form an array of resonators to attenuate acoustic energy generated by the device; and an additional one-piece, unitary, acoustic liner disposed in the casing; the additional liner comprising a unitary plate, and a plurality of cells formed in the plate in a manner to form an array of resonators to attenuate acoustic energy generated by the device.

11. The device of claim 10 wherein the resonators are either Helmholtz resonators or quarter-wave resonators.

12. The device of claim 10 wherein the liners are disposed in an abutting relationship in the casing.

13. The device of claim 12 wherein the cells of the additional liner are aligned with the cells of the first-mentioned liner.

14. The device of claim 10 wherein the cells of each liner are in the form of a first series of openings extending from one surface of the plate, and a second series of openings extending from the opposite surface of the plate.

15. The device of claim 14 wherein a plurality of openings of each second series of openings extend to one of each of the corresponding first series of openings.

16. The device of claim 14 wherein each opening of the first series of openings is larger than each opening of the second series of openings.

17. The device of claim 14 wherein the surface of the first-mentioned liner through which the first series of opening extends abuts the surface of the additional liner through which the second series of cells extend.

18. The device of claim 14 wherein the first and second series of openings of each liner are uniformly dispersed in their corresponding plate.

19. The device of claim 14 wherein the number and size of the openings of each liner are constructed and arranged to attenuate the dominant noise component of the acoustic energy.

20. The device of claim 10 wherein the first-mentioned liner is attached to a wall defining a portion of the chamber and the additional liner abuts the first-mentioned liner.

21. The device of claim 20 further comprising at least one-piece, unitary, acoustic liner disposed in the casing and attached to a wall defining a portion of the chamber and extending opposite the first-mentioned wall, the last-mentioned liner comprising a unitary plate, and a plurality of cells formed in the plate in a manner to form an array of resonators to attenuate acoustic energy generated by the device.

22. The device of claim 10 wherein the casing further comprises a diffuser area in fluid flow communication with the impeller passages and the outlet, and wherein the first-mentioned liner is attached to a wall defining a portion of the diffuser area, and the additional liner abuts the first-mentioned liner.

23. The device of claim 10 further comprising an inlet conduit connected to the inlet for supplying fluid to the inlet, and further comprising a liner attached to the inlet conduit and comprising a unitary curved shell, and a plurality of cells formed in the shell in a manner to form an array of resonators to attenuate additional acoustic energy generated by the device.

24. The device of claim 23 further comprising a liner extending around the liner attached to the inlet conduit and comprising a unitary curved shell, and a plurality of cells formed in the shell in a manner to form an array of resonators to attenuate additional acoustic energy generated by the device.

25. A fluid pressurizing device comprising a casing defining an inlet and an outlet; an impeller mounted in the chamber and adapted to rotate to flow fluid from the inlet and to the outlet for discharge from the casing; a conduit connected to the inlet for supplying fluid to the inlet; a one-piece, unitary, acoustic liner attached to the conduit, the liner comprising a curved shell, and a plurality of cells formed in the shell in a manner to form an array of resonators to attenuate acoustic energy generated by the device; and an additional one-piece, unitary, acoustic liner extending around the first-mentioned conduit in an abutting relationship thereto, the additional comprising a curved shell, and a plurality of cells formed in the shell in a manner to form an array of resonators to attenuate acoustic energy generated by the device.

26. The device of claim 25 wherein the cells of the additional liner are aligned with the cells of the first-mentioned liner.

27. The device of claim 25 wherein the cells of each liner are the form of a first series of openings extending from one surface of the plate, and a second series of openings extending from the opposite surface of the plate.

28. The device of claim 27 wherein a plurality of openings of the second series of openings extend to one of each of the first series of openings of each liner.

29. The device of claim 27 wherein each opening of the first series of openings is larger than each opening of the second series of openings of each liner.

30. The device of claim 27 wherein the surface of the first-mentioned liner through which the first series of opening extends abuts the surface of the additional liner through which the second series of cells extend.

31. The device of claim 27 wherein the first and second series of openings of liner are uniformly dispersed in their corresponding plate.

32. The device of claim 27 wherein the number and size of the openings are constructed and arranged to attenuate the dominant noise component of the acoustic energy.

33. The device of claim 25 wherein the first-mentioned liner is attached to the inner wall of the conduit and the second-mentioned liner abuts the first-mentioned liner.

34. A noise attenuation method for a fluid pressurizing device in which an impeller rotates to flow fluid through a casing; comprising a one-piece, unitary, acoustic liner disposed in the casing and having a plurality of cells forming an array of resonators; providing an additional a one-piece, unitary, acoustic liner disposed in the casing and having a plurality of cells forming an array of resonators, and tuning the resonators to the impeller blade passing frequency to increase the noise reduction.

35. The method of claim 34 wherein the step of tuning comprises varying the number, size and/or volume of the cells.
